(19) United States
(12) Patent Application Publication
(10) Pub. No.: US 2024/0300364 A1
(43) Pub. Date: Sep. 12, 2024

(54) DECENTRALIZED POWER SYSTEM AND CHARGING STATIONS FOR ELECTRIC VEHICLES

(71) Applicant: Siemens Aktiengesellschaft, München (DE)

(72) Inventors: Jan Wieghardt, München (DE); Martin Seydenschwanz, Erfurt (DE); Harald Held, Bockhorn (DE); Kurt Majewski, München (DE); Veronika Liebig, München (DE); Jeremy Ralph Wiles, Vigo Cavedine (IT)

(21) Appl. No.: 18/119,908

(22) Filed: Mar. 10, 2023

(51) Int. Cl. B60L 53/64; H02J 7/00

(52) U.S. Cl. CPC B60L 53/64; H02J 7/0071; H02J 2203/10; H02J 2203/20; H02J 2300/20

(57) ABSTRACT

The disclosure pertains to optimizing a charging strategy for one or more charging stations to which one or more electric vehicles are connected. The charging strategy is optimized taking into account power generation within a decentral energy system, also referred to as microgrid.

### FIELD OF TECHNOLOGY

Various examples of the disclosure pertain to simulation of power generation by one or more electric power sources of a decentralized power system. Various examples of the disclosure specifically pertain to optimization of a charging strategy of a charging station for electric vehicles, the charging station being connected to the local grid.

### BACKGROUND

Power systems are in a transition phase worldwide. Decentral energy systems are proliferating. A decentral energy system includes power generation by one or more electric power sources connected to a local power grid of the decentral energy system. Optionally, the decentral energy system also includes one or more electric loads that consume the power.

Simulation tools are available to simulate power generation by one or more electric power sources of the decentral energy system. See, e.g., Rui Han, Ben Gemsjaeger, and Tongtong Akerman. “Design of Decentral Energy System-Optimized Energy Supply on Basis of PSS® DE.” (2018).

A user can connect individual electric power sources such as a generator, gas turbine, battery, photovoltaic, or other components to either electric, thermal, or hydrogen loads. The performance of such equipment is then simulated over its lifetime (e.g., 20 years). The simulation enables evaluation of the decentral power system according to, e.g., technical feasibility (e.g., blackouts, unmet load, total exports).

### SUMMARY

According to various examples, a need exists for taking into consideration charging stations for electric vehicles (EVs), the EV charging stations being connected to a decentral energy system.

This need is met by the features of the independent claims. The features of the dependent claims define embodiments.

Various disclosed techniques enable designing an energy infrastructure for delivering electric power to one or more EV charging station and deciding how many charging stations are required. Various disclosed techniques enable simulation of a decentral energy system taking that includes one or more EV charging stations. The decentral energy system may include, e.g., between and 200 EV charging stations.

A computer-implemented method is disclosed. The computer-implemented method includes performing a simulation of power generation by one or more electric power sources of a decentral energy system during a simulation duration.

Example electric power sources include but are not limited to: generator; gas turbines; battery; stationary energy storage device; photovoltaic energy source; wind power source.

According to examples, the central energy system also includes one or more electric loads. According to examples, the simulation also is with respect to power consumption by the one or more electric loads. The electric loads can include, e.g., computer equipment, servers, lighting, etc.

The simulation duration can be, e.g., not less than 1 day, optionally not less than a week, optionally not less than a month. Typical simulation durations can be in the order of months or years.

The method includes obtaining a vehicle schedule defining presence time windows during the simulation duration. One or more EVs are connected to the charging station of the decentral energy system during the presence time windows.

The presence time window accordingly can specify a start timepoint at which an EV is connected to one of the one or more EV charging stations; and a stop timepoint at which the EV is again disconnected.

Accordingly, the vehicle schedule defines, e.g., amongst other information associated with the operation of the EV, when a certain EV charging station is being visited by an EV. The vehicle schedule defines when the certain EV charging station is not connected to an EV. The vehicle schedule does not need to define when exactly during the presence time window a certain EV is being charged or being discharged.

The method further includes performing an optimization of a charging strategy of the charging station based on the power generation during the simulation duration and the vehicle schedule. Optionally, power consumption during the simulation duration by one or more electric loads of the decentral energy system can be considered.

Optimization of the charging strategy can include setting a start timepoint for charging the EV and/or setting a charging rate. Charging can be delayed to a later point in time during the presence time window. The charging rate can be limited. By setting the charging time window and/or setting the charging rate, the impact of the charging procedure of the EV onto the energy balance of the decentralized energy system can be tailored.

Optimization of the charging strategy can include activating discharging of the battery of the EV into the decentralized energy system. A discharging time window can be set. By discharging into the decentralized energy system, a negative energy balance of the remaining nodes of the decentralized energy system can be compensated.

The charging strategy generally defines when and how fast any given EV connected to one of the EV charging stations of the decentralized energy system is charged and/or discharged.

A computer program includes program code that can be executed by at least one processor. The at least one processor, upon executing the program code, performs a simulation of power generation. The power generation is by one or more electric power sources of a decentral energy system. The simulation is for a simulation duration. The at least one processor, upon executing the program code, further obtains a vehicle schedule. The vehicle schedule defines presence time windows during the simulation duration. One or more electric vehicles are connected to one or more charging stations of the decentral energy system during the presence time window. The at least one processor, upon executing the program code, further performs an optimization of a charging strategy of the one or more charging stations. The optimization is based on the power generation during the simulation duration and further based on the vehicle scheduled.

A computing device comprises at least one processor in the memory. The at least one processor is configured to load program code from the memory and to execute the program code. The at least one processor, upon loading and executing the program code performs a computer-implemented method. The computer-implemented method includes performing a simulation of power generation by one or more electric power sources of a decentral energy system during a simulation duration; and obtaining a vehicle schedule defining presence time windows during the simulation duration, one or more electric vehicles being connected to one or more charging stations of the decentral energy system during the presence time window; and performing an optimization of a charging strategy of the one or more charging stations based on the power generation during the simulation duration and further based on the vehicle schedule.

It is to be understood that the features mentioned above and those yet to be explained below may be used not only in the respective combinations indicated, but also in other combinations or in isolation without departing from the scope of the invention.

### BRIEF DESCRIPTION

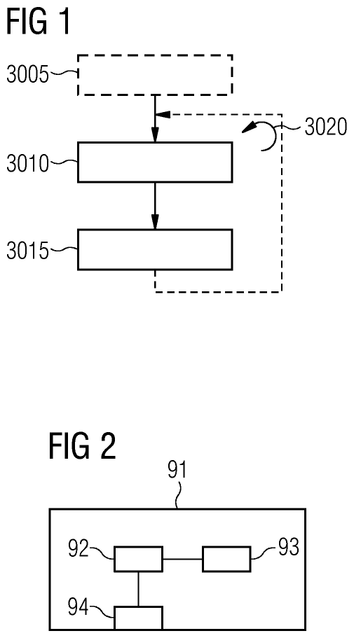

FIG. 1 is a flowchart of a method according to various examples.

FIG. 2 illustrates a processing device according to various examples.

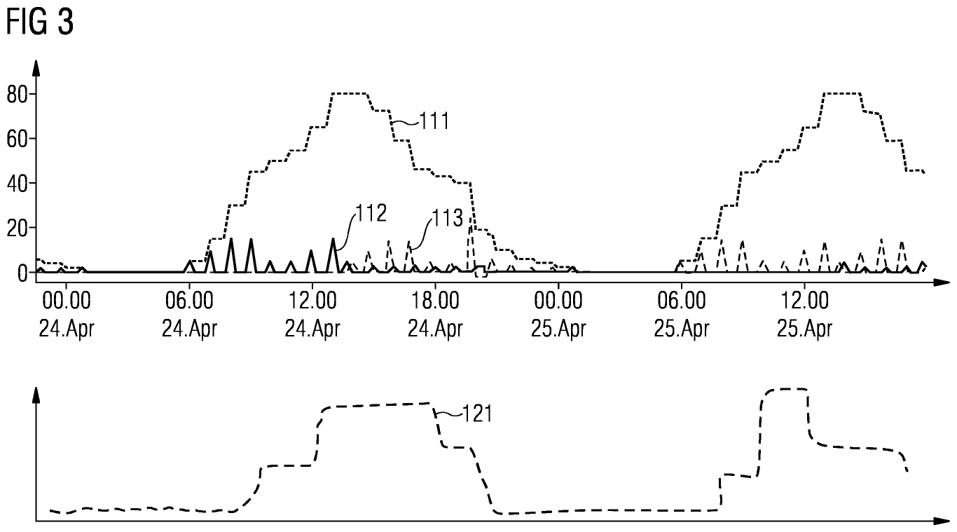

FIG. 3 illustrates a vehicle schedule according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which coact with one another to perform operation(s) disclosed herein. In addition, any one or more of the electrical devices may be configured to execute a program code that is embodied in a nontransitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

FIG. 1 is a flowchart of a method according to various examples. The method of FIG. 1 is computer-implemented. Accordingly, a processor can execute the method of FIG. 1 based on program code that is loaded from a memory and then executed by the processor. Optional boxes are shown with dashed lines.

The method of FIG. 1 generally pertains to performing a simulation of a decentral energy system. The decentral energy system implements a local power grid (sometimes also referred to as microgrid). The decentral energy system can be connected to a public power grid at one or more connection nodes. The decentral energy system can have a maximum power balance of 200 kilowatts to 10 megawatts. The decentral energy system includes multiple nodes. The nodes generate power and/or consume power.

Based on such simulation of the decentral energy system, it is possible to optimize a charging strategy of multiple EV charging stations of the decentral energy system.

At box 3005, subsequent calculations are initialized. This includes parameterizing the simulation. This means that one or more simulation parameters are set. Also, parameters of the optimization of the charging strategy of EVs connected to the EV charging stations are set at box 3005.

First, parameterization of the optimization of the charging strategy is discussed.

It is possible to obtain, from a user interface (e.g., a graphical user interface, GUI that may or may not be web based), information associated with one or more goal functions of the optimization of the charging strategy. For example, a goal function can include/define multiple objectives. Relative weighting factors of the multiple objectives can be set based on such user inputs. thereby, different objectives can be flexibly prioritized by the user. An example objective is to reach a target state of charge (SOC) at the end of the presence time window of any given EV. The target SOC can be pre-defined or defined in a vehicle schedule.

Box 3005 can alternatively or additionally include obtaining the vehicle schedule. The vehicle schedule can define certain properties of each EV that is considered in the calculation. The vehicle schedule can define certain charging and/or discharging parameters. The vehicle schedule can define properties of the EV traction battery.

The vehicle schedule can be indicative of the behavior of EVs resolved in time domain. For instance, the behavior of each of one or more EVs can be specified on an hourly basis. In other words, the behavior of the EV with respect to the EV charging stations of the decentral energy system can be specified in a time-resolved manner.

The vehicle schedule can define presence time windows during the simulation duration of the simulation. These presence time window specify time durations during which one or more EVs are connected to an EV charging station of the decentral energy system or can be potentially connected to an EV charging stations (e.g., if all EV charging stations are currently occupied).

The vehicle schedule can define an initial SOC for each EV. Each EV arrives at the EV charging stations at an initial SOC.

The vehicle schedule can define the target SOC for each EV. This is the goal SOC to be reached at the end of the presence time windows.

According to examples, the vehicle schedule further defines a penalty associated with not reaching the target SOC at the end of the presence time windows. In other words, it is possible that the target SOC is not a fixed constraint of the optimization that has to be met under all circumstances; rather, the target SOC can be a soft objective, wherein any deviation from the target SOC is penalized, e.g., by a certain cost.

Such vehicle schedule can also be indicative of one or more of the following static parameters associated with each EV: battery capacity of a certain EV; and/or whether the EV can discharge electric energy into the decentral energy system through the EV charging station; a minimum charging rate; a maximum charging rate; a minimum discharging rate; a maximum discharging rate; a minimum SOC; a maximum SOC; a charging efficiency; a discharging efficiency; an efficiency of electric power consumption per travelled distance for the EV.

According to examples, the vehicle schedule differentiates between different vehicle types such as a mid-sized EV, a large-sized EV, a small-sized EV, a truck EV, or a bus EV.

By means of the vehicle schedule, the parameters governing the charging or discharging process of an EV that is connected to an EV charging station can be set. Based on such properties, it is possible to determine a charging strategy for an EV that meet certain objectives.

Above, various aspects with respect to parametrizing the optimization of the charging strategy have been disclosed. Beyond such parameterization of the EV charging stations and the vehicle schedule, also for the parameters of the decentral energy system can be parametrized. This is used for simulating the decentralized energy system, i.e., power generation and optionally power consumption. This includes adding or removing electric power sources; adding or removing electric power loads; for each electric power source and each electric power load, specifying respective operational parameters; specifying the impact of weather onto such nodes of the decentral energy system; defining a weather model; etc. The parameterization of the decentral energy system for nodes other than the EV charging station is out of scope of the subject application in reference techniques can be employed.

Instead of obtaining parameters via a user interface at box 3005, respective parameters can also be predefined and fixed. Box 3005 is optional.

At box 3010, a simulation of power generation by one or more electric power sources of the decentral energy system is performed. If the decentral energy system includes one or more electric loads—other than EV charging stations—, also the power consumption of the one or more electric loads is subject to the simulation. The simulation is for a simulation duration. Typical simulation durations or months or years. Reference techniques can be employed to perform such simulation. See, e.g., Rui, Han, Ben Gemsjaeger, and Tongtong Akerman. “Design of Decentral Energy System-Optimized Energy Supply on Basis of PSS® DE.” (2018).

At box 3015, an optimization of a charging strategy of the EV charging station of the decentral energy system is performed. This is based on an output of box 3010; for instance, the power generation and/or the power consumption obtained from the simulation performed at box 3010 can be considered when performing the optimization of the charging strategy. The optimization of box 3015 also takes into account the vehicle schedule obtained at box 3005.

Box 3015 can include: Based on the period that the EV is at the EV charging station (presence time window), the necessary energy needed to charge the EV. The optimization determines a day-ahead (24 hour) schedule of how each one of the one or more EVs is charged (charging strategy), taking into account EV availability/flexibility, costs e.g. energy costs varying over a 24 hour period (as determined in box 3010), capacity or demand charges (as determined in box 3010), renewables (as determined in box 3010), assets that are available, e.g., energy storage systems (ESSs) (as determined in box 3010).

Such optimization is based on a goal function that can include one or more objectives. The objectives can be relatively weighted with respect to each other. Respective weighting factors can be obtained from a user in box 3005 can be fixed.

In an example, the excess electric power of the decentralized energy system (as determined in box 3010) is used for charging EVs. It can be checked whether target SOCs can be reached.

In another example, as illustrated in FIG. 1, it is possible that there is feedback from box 3015 to box 3010. This defines multiple iterations 3020 of box 3010 and box 3015 being executed. According to various examples, the simulation of the power generation and optionally the power consumption of the decentral energy system executed at box 3010 depends on the optimization at box 3015 (and vice versa). According to examples, the performing of the simulation of the power generation and optionally of the power consumption at box 3010 includes performing an optimization of the power generation by the one or more power sources. Such optimization of the power generation executed at box 3010 is coupled with the optimization of the charging strategy.

I.e., a combined goal function can be considered with respect to the optimization of the power generation as well as the charging strategy and overall optimization of one or more objectives of such combined goal function can be achieved. The optimization of the power generation and the optimization of the charging strategy are then executed in an interleaved manner, i.e., alternatingly, as illustrated in FIG. 1 by the feedback of iterations 3020, for rolling time increments—e.g., hours or minutes—within the simulation duration. This enables to determine the power balance of the decentralized energy system in a time increment, then use this power balance (e.g., net available power for charging) as an input parameter to tailor the charging strategy for that time increment, and feedback whether the vehicle is charged or not charged in the time increment as input parameter to determining the power balance of the decentralized energy system in the next time increment.

As an effect, the power generation strategy can be tailored to the charging strategy of one or more EV vehicles, and vice versa the charging strategy of the one or more EV vehicles can be tailored to the power generation strategy. Overall objectives can be considered, e.g., how to reduce net intake of electric energy from a public supplier grid while still reasonably fulfilling target SOCs of EVs being charged; or how to reduce overall carbon dioxide emissions/pollutant emission while still reasonably fulfilling target SOCs.

In particular, this enables to optimize the charging strategy by appropriately setting one or more charging time windows during the presence time window in accordance with the power generation of the one or more electric power sources. For each EV, the charging time window or windows can define those time durations during which that EV is being charged. For any given EV, the one or more charging time windows can form a subset of the total presence time window of that given EV. The EV is charged during the one or more charging time windows. The EV is not charged outside of the one or more charging time windows. The one or more charging time windows do not necessarily have to be at the beginning of the presence time window. In other words, charging of the EV can be delayed in accordance with the charging strategy. Charging of the EV can be delayed in accordance with the power generation by electric power sources of the decentral energy system. In other words, the one or more charging time windows can be set in accordance with the optimization of the power generation of box 3010.

To give an example, solar power sources are expected to generate power during daytime when the sun is shining. The charging time windows can be optimized to coincide with such time durations during which solar power sources generate power. In other words, charging time windows can be shifted back and forth in time during the presence time windows, to thereby optimize the charging strategy and optimize the operation of the decentral energy system. For instance, a vehicle may—in accordance with the vehicle schedule—become connected to the EV charging station during nighttime. Then, charging is not immediately triggered; but rather the charging time window is delayed until a solar power source connected to the decentral energy system starts to generate electric power after sunrise.

The optimization at box 3010 can maximize or minimize an output value of a goal function. The goal function can be subject to coupled optimizations at boxes 3005 and 3010, i.e., an overall goal function can be used. In another scenario, the goal function may only pertain to the optimization at box 3010. In another scenario, the goal function may only pertain to the optimization at box 3005.

The goal function can include one or more objectives that are specified by such output value. Where multiple objectives are included, they can be relatively weighted. Various objectives are disclosed below. The goal function can penalize emission of pollutants (e.g., carbon dioxide) by the one or more power sources of the decentral energy system. This is only one example. Alternatively, or additionally, the goal function can penalize electric power injected into the decentral energy system from the supplier grid. I.e., the amount of electric power that is externally supplied from a public supplier grid can be minimized. This can help to reduce costs for obtaining such energy from the supplier grid. Alternatively, or additionally, the amount of electric power that is injected into the supplier grid from the decentral energy system can be minimized. Thus, electric power can be primarily locally consumed or stored within the decentral energy system and only secondarily replaced into the public supplier grid. Specifically, one option for locally consuming electric powers charging EV vehicles; so, the charging strategy can be optimized accordingly at box 3015. Alternatively, or additionally, operating costs of the electric power grid can be minimized. It would be possible to maximize revenue of the electric power grid. It would be possible to maximize a fulfillment ratio of the target SOC. The optimization can maximize or minimize a goal function that penalizes deviations from a target SOC as specified in the vehicle schedule. For instance, where a soft target SOC is defined deviations from the target SOC may be possible but penalize. This helps to fulfill user requirements regarding the target SOC. Alternatively or additionally the optimization of box 3015 includes a goal function that penalizes larger charging rates or discharging rates of the charging station. Thereby, slow charging or slow discharging is preferred; thereby reducing aging of the battery due to fast charging of fast discharging.

Above, various objectives of one or more goal functions associated with box 3010 and/or box 3015 have been discussed. Such objectives can be used in isolation or in combination with each other. further objectives not mentioned above may be used instead or in addition.

FIG. 2 illustrates a computing device 91. The computing device 91 includes a processor 92 in the memory 93. The processor 92 can load program code from the memory 93 and execute the program code. The processor 92 can receive input from a user via a user interface 94 and provide output to the user via the user interface 94. The processor 92, based on the program code stored in the memory 93, can perform techniques as disclosed herein, e.g., in connection with FIG. 1.

FIG. 3 schematically illustrates aspects with respect to the vehicle schedule for multiple EVs. FIG. 3 illustrates the total amount of EVs present at one or more EV charging stations of a decentralized power system. The number of EVs that are present at the EV charging stations changes from 0 at around 5 AM in the morning of April 24 to around 80 vehicles at 2 PM of April 24 and then drops again to zero at 1 AM of the next day, April 25. These are arbitrarily selected days during a simulation duration of, e.g., months or years.

Also, line 112 illustrates the EVs arriving at the EV charging stations of the decentralized power system. Line 113 illustrates the EVs leaving from the EV charging stations. The vehicle schedule accordingly defines, for each of these EVs, presence time windows.

Also illustrated in FIG. 3, bottom, using line 121 is the aggregated generated power and the decentralized power system, using solar power sources in this case. This is determined at box 3010. The charging time windows for charging the EVs can be optimized in time domain to coincide with time durations of large photovoltaic power generation.

Similar to such time dependency of the photovoltaic power generation as illustrated in FIG. 3, box 3010 also allows to calculate the amount of power are retrieved from the public grid, the amount of power released into the public grid, the amount of power generated by alternative power sources (if any), the amount of power consumed by other power loads (if any).

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1. A computer-implemented method, comprising:
performing a simulation of power generation by one or more power sources of a decentral energy system during a simulation duration,
obtaining a vehicle schedule defining presence time windows during the simulation duration, one or more electric vehicles being connected to one or more charging stations of the decentral energy system during the presence time windows, and
performing an optimization of a charging strategy of the one or more charging stations based on the power generation during the simulation duration and further based on the vehicle schedule.

2. The computer-implemented method of claim 1, further comprising:
when performing the simulation of the power generation: performing an optimization of the power generation by the one or more power sources, the optimization of the power generation being coupled with the optimization of the charging strategy.

3. The computer-implemented method of claim 2,
wherein the optimization of the power generation and the optimization of the charging strategy are executed interleaved for rolling time increments within the simulation duration.

4. The computer-implemented method of claim 2,
wherein the optimization of the power generation maximizes or minimizes an output value of a goal function, the goal function penalizing emission of pollutants by the one or more power sources of the decentral energy system.

5. The computer-implemented method of claim 2,
wherein the optimization of the power generation maximizes or minimizes an output value of a goal function, the goal function penalizing electric power injected into the decentral energy system from a supplier grid.

6. The computer-implemented method of claim 1,
wherein the optimization of the charging strategy sets charging time windows during the presence time windows, the one or more electric vehicles being charged during the charging time windows and not being charged outside of the charging time windows.

7. The computer-implemented method of claim 6,
wherein the one or more charging time windows are set in accordance with the optimization of the power generation.

8. The computer-implemented method of claim 1,
wherein the vehicle schedule further defines a target state of charge of the one or more electric vehicles at an end of the presence time windows.

9. The computer-implemented method of claim 8,
wherein the vehicle schedule further defines a penalty associated with not reaching the target state of charge at the end of the presence time windows.

10. The computer-implemented method of claim 9,
wherein the optimization of the charging strategy maximizes or minimizes an output value of a goal function, wherein the goal function minimizes the penalty.

11. The computer-implemented method of claim 1,
wherein the optimization of the charging strategy maximizes or minimizes an output value of a goal function, the goal function penalizing larger charging rates or discharging rates of the one or more charging station.

12. The computer-implemented method of claim 1,
wherein the vehicle schedule further defines an initial state of charge of the one or more electric vehicles at a beginning of the presence time windows.

13. The computer-implemented method of claim 1,
wherein the vehicle schedule further defines whether the one or more electric vehicles can discharge electric energy into the decentral energy system through the one or more charging station.

14. The computer-implemented method of claim 1,
wherein the vehicle schedule further defines at least one of a charging rate or a discharging rate of the one or more electric vehicles.

15. The computer-implemented method of claim 1,
wherein the optimization of the charging strategy and/or one of more optimizations of the simulation are based on a goal function,
wherein the goal function comprises multiple objectives,
wherein relative weighting factors of the multiple objectives are set based on a user input.
